(19) United States
(12) Patent Application Publication
(10) Pub. No.: US 2024/0224199 A1
(43) Pub. Date: Jul. 4, 2024

(54) USER EQUIPMENT, NETWORK NODE AND METHODS IN A WIRELESS COMMUNICATIONS NETWORK

(71) Applicant: Telefonaktiebolaget LM Ericsson (publ), Stockholm (SE)

(72) Inventors: Jan CHRISTOFFERSSON, Luleå (SE); Henrik ENBUSKE, Stockholm (SE)

(21) Appl. No.: 18/557,436

(22) PCT Filed: Apr. 14, 2022
(86) PCT No.: PCT/SE2022/050374

§ 371 Date: Oct. 26, 2023

Related U.S. Application Data
(60) Provisional application No. 63/181,261, filed on Apr. 29, 2021.

(51) Int. Cl. H04W 52/36; H04W 28/02; H04W 74/0833; H04W 76/20

(52) U.S. Cl. CPC H04W 52/365; H04W 28/0278; H04W 74/0833; H04W 76/20

(57) ABSTRACT

A method performed by a User Equipment (UE) is provided. The method is for handling a Power Headroom Report, PHR, in a Small Data Transmission, SDT, to a network node in a wireless communications network. The UE is in a Radio Resource Control, RRC, inactive state. The UE obtains buffer status information related to a data volume for a SDT included in a buffer in the UE. When the data volume for an SDT to be transmitted to the network node requires at least one transmission after a Random Access, RA, procedure, according to the buffer status information, the UE triggers a PHR. The PHR is to be transmitted to the network node.

### TECHNICAL FIELD

Embodiments herein relate to a User Equipment (UE), a network node and methods therein. In some aspects, they relate to handling a Power Headroom Report (PHR) in a Small Data Transmission (SDT) from the UE to the network node in a wireless communications network.

Embodiments herein further relates to computer programs and carriers corresponding to the above methods, UE, and network node.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### NR Small Data Transmissions in Inactive State

A new Work Item (WI) RP-200954 “New Work Item on NR small data transmissions in INACTIVE state” has been approved in 3GPP with the focus of optimizing the transmission for small data payloads by reducing the signaling overhead. Note that the wordings inactive state and RRC inactive state may be used interchangeably in this document.

The WI contains the following objectives:

This WI enables Small Data Transmission (SDT) in Radio Resource Control (RRC)
Inactive State (RRC_INACTIVE; INACTIVE) as follows:
For the RRC_INACTIVE state:
Uplink (UL) small data transmissions for Random Access Channel (RACH) based
schemes (i.e. 2-step and 4-step RACH):
General procedure to enable UP data transmission for small data packets from
INACTIVE state (e.g. using Message A (MSGA) or Message 3 (MSG3) [RAN2].
Enable flexible payload sizes larger than the Release 16 (Rel-16) Common
Control Channel (CCCH) message size that is possible currently for INACTIVE state for
MSGA and MSG3 to support UP data transmission in UL (actual payload size can be up
to network configuration) [RAN2].
Context fetch and data forwarding (with and without anchor relocation) in
INACTIVE state for RACH-based solutions [RAN2, RAN3].
Note 1: The security aspects of the above solutions should be checked with SA3.
Transmission of UL data on pre-configured Physical Uplink Shared Channel
(PUSCH) resources (i.e. reusing the configured grant type 1) - when Timing Advance
(TA) is valid
General procedure for small data transmission over configured grant type 1
resources from INACTIVE state [RAN2].
Configuration of the configured grant type1 resources for small data transmission
in UL for INACTIVE state [RAN2].

For Narrowband (NB) Internet of Things (IoT) and Long Term Evolution for Machines (LTE-M) with similar signaling optimizations for small data have been introduced through Release (Rel) 15 Early Data Transmission (EDT) and Rel-16 Preconfigured Uplink Resources (PUR). Somewhat similar solutions may be expected for NR with the difference that the Release 17 (Rel-17) NR Small Data is only to be supported for RRC INACTIVE state, also includes 2-step RACH based small data, and that it should also include regular complexity Mobile Broadband (MBB) UEs. Both support Mobile Originated (MO) traffic only.

Within the context of SDT the possibility of transmitting subsequent data has been discussed. Transmitting subsequent data used herein means a transmission of further segments of data that cannot fit in the Message 3 (Msg3) Transport Block. Such segments of data may be transmitted either in RRC Connected State (RRC_CONNECTED; CONNECTED) as in legacy methods after the 4-step RACH procedure has been completed, or they may be transmitted in RRC_INACTIVE before the UE transitions to RRC_CONNECTED. In the former case, the transmission will be more efficient as the gNB and UE are appropriately configured based on the current UE channel conditions. In the latter case several optimizations are not in place yet, especially if the UE has moved while not connected. Furthermore, the transmission may collide with the transmission from other UEs as the contention has not been resolved yet.

A WI regarding SDT has started with 3GPP meeting RAN2 #111-e, and the following relevant agreements have already been made:
SDT with RRC message is supported as a baseline for RA based and Configured Grant (CG) based schemes.
The 2-step RACH or 4-step RACH should be applied to RACH based UL SDT in RRC_INACTIVE.
The UL small data can be sent in Message A (MsgA) of 2-step RACH or Msg3 of 4-step RACH.
SDT is configured by the network on a per Data Radio Bearer (DRB) basis.
A data volume threshold is used for a UE to decide whether to use SDT or not. It is left For Further Study (FFS) on how to calculate said data volume.
It is also left for further study if an, e.g. additional SDT specific, Reference Signal Receive Power (RSRP) threshold is further used to determine whether the UE should use SDT or not.
UL and/or Downlink (DL) transmission following UL SDT without transitioning to RRC_CONNECTED is supported.
When a UE is in RRC_INACTIVE, it should be possible to send multiple UL and DL packets as part of the same SDT mechanism and without transitioning to RRC_CONNECTED on a dedicated grant. It is left for further study on details and whether any indication to network is needed.

In other words, in the above referenced NR Rel-17 SDT WI, two main solutions will be specified for enabling SDT in RRC_INACTIVE state, namely:
A RACH based SDT, i.e., transmitting small data on Message A PUSCH in a 2-step RACH procedure, or transmitting small data on Message 3 PUSCH in a 4-step RACH procedure, and
a CG based SDT, i.e., SDT over configured grant type-1 PUSCH resources for UEs in RRC inactive state.

The 4-step RACH, 2-step RACH, and configured grant type have already been specified as part of Rel-15 and Rel-16. Hence, the SDT features to be specified in NR Rel-17 build on these building blocks to enable SDT in INACTIVE state for NR.

In RAN2 #112-e the following agreements have been made:

Agreements
1. The configuration of configured grant resource for UE uplink small data transfer is
contained in the RRC Release (RRCRelease) message. FFS if other dedicated messages
can configure CG in INACTIVE CG. Configuration is only type 1 CG with no contention
resolution procedure for CG.
2. The configuration of configured grant resource can include one type 1 CG
configuration. FFS if multiple configured CGs are allowed.
3. A new TA timer for TA maintenance specified for configured grant based small
data transfer in RRC_INACTIVE should be introduced. FFS on the procedure, the validity
of TA, and how to handle expiration of TA timer. The TA timer is configured together with
the CG configuration in the RRCRelease message.
4. The configuration of configured grant resource for UE small data transmission is
valid only in the same serving cell. FFS for other CG validity criteria (e.g. timer, UL and/or
Supplementary Uplink (SUL) aspect, etc).
5. The UE can use configured grant based small data transfer if at least the
following criteria is fulfilled (1) user data is smaller than the data volume threshold; (2)
configured grant resource is configured and valid; (3) UE has valid TA. FFS for the
candidate beam criteria.
6. From RAN2 point of view: An association between CG resources and SSBs is
required for CG-based SDT. FFS up to RAN1 how the association is configured or
provided to the UE. Send an LS to RAN1 to start the discussion on how the association
can be made. Mention that one option RAN2 considered was explicit configuration with
RRC Release message.
7. A Synchronization Signal (SS) RSRP (SS-RSRP) threshold threshold is
configured for Synchronization Signal Blocks (SSBs) selection. UE selects one of the SSB
with SS-RSRP above the threshold and selects the associated CG resource for UL data
transmission.

In RAN2 #113-e, and the following agreements have been made:

Agreements
1. CG-SDT resource configuration is provided to UEs in RRC_Connected only
within the RRCRelease message, i.e. no need to also include it in RRC Reconfiguration
(RRCReconfiguration) message
2. CG-PUSCH resources can be separately configured for NUL and SUL. FFS if we
allow them at the same time. This depends on the alignments Change Requests (CRs) for
Rel-16.
3. RRCRelease message is used to reconfigure or release the CG-SDT resources
while UE is in RRC_INACTIVE
4. For CG-SDT the subsequent data transmission can use the CG resource or DG
(i.e dynamic grant addressed to UE's C-RNTI). Details on C-RNTI, can be the same as
the previous C-RNTI or may be configured explicitly by the network can be discussed in
stage 3
5. Time Alignment Timer (TAT) SDT (TAT-SDT is started upon receiving the TAT-
SDT configuration from gNB, i.e. RRCrelease message, and can be (re)started upon
reception of TA command.
6. From RAN2 point of view, assume similar to PUR, that we introduce a TA
validation mechanism for SDT based on RSRP change, i.e. RSRP-based threshold(s) are
configured. Ask RAN1 to confirm. FFS on how to handle CG configuration when TA
expires or when is invalid due to RSRP threshold. Details of the TA validation procedure
can be further discussed.
7. As a baseline assumption, it's a network configuration issue whether to support
multiple CG-SDT configurations per carrier in RRC_INACTIVE (i.e. we will not restrict
network configuration for now).
8. FFS Discuss further in stage 3 how to specify the agreement that CG-SDT
resources are only valid in one cell (i.e. cell in which RRCRelease is received)
9. UE releases CG-SDT resources when TAT expires in RRC_Inactive state

Agreements
1. For Random Access (RA) SDT (RA-SDT), up to two preamble groups
(corresponding to two different payload sizes for MSGA/MSG3) may be configured by the
network
2. [CB] UE performs carrier selection as per legacy procedure and then the UE
determines whether SDT can be initiated.
3. [CB] Upon initiating SDT, after the carrier selection, if valid CG-SDT resource
exists, then CG-SDT is chosen, otherwise UE proceeds to RA-SDT procedure.
4. If RACH procedure is initiated for SDT (i.e. RA-SDT initiated), the UE first
performs RACH type selection as specified in Medium Access Control (MAC) (i.e. Rel-16).
FFS whether threshold is SDT specific or not.

Agreements
1. RAN2 continues to progress the work based the separate RACH resources for
SDT (i.e. explicit mechanisms to support common resources won't be pursued unless
there is sufficient support for this. However, use of common RACH resources will not be
precluded if possible via implementation
2. RAN2 design assumes that RRCRelease message is sent at the end to terminate
the SDT procedure from RRC point of view. The RRCRelease sent at the end of the SDT
may contain the CG resource (as per previous agreement). Write an LS to SA3 to explain
SDT procedure and agreement.
3. The UE behaviour for handling of non-SDT data arrival after sending the first UL
data packet is fully specified (i.e. not left to UE implementation).

### 4-Step RA Type

The 4-step RA type has been used in 4G LTE and is also the baseline for 5G NR. The principle of this procedure in NR is shown in a signalling diagram illustrating signalling between a UE and an eNB of FIG. 1.

### Step 1: Preamble Transmission

The UE randomly selects a RA preamble (PREAMBLE_INDEX) corresponding to a selected SS and/or Physical Broadcast Channel (PBCH) block, transmit the preamble on the Physical Random Access Channel (PRACH) occasion mapped by the selected SS/PBCH block. When the gNB detects the preamble, it estimates the TA the UE should use in order to obtain UL synchronization at the gNB.

### Step 2: RA Response

The gNB sends a RA Response (RAR) including the TA, a Temporary Identifier (TC-RNTI) to be used by the UE, a Random Access Preamble identifier that matches the transmitted PREAMBLE_INDEX and a grant for Msg3. The UE expects the RAR and thus, monitors the physical downlink control channel (PDCCH) addressed to RA-RNTI to receive the RAR message from the gNB until a configured RAR window, also referred to as an ra-ResponseWindow, has expired or until the RAR has been successfully received.

3GPP TS38.321 discloses that the MAC entity may stop ra-ResponseWindow, and hence monitoring for Random Access Response(s), after a successful reception of a Random Access Response containing Random Access Preamble identifiers that matches the transmitted PREAMBLE_INDEX.

### Step 3: Msg3, UE ID or UE-Specific C-RNTI

In Msg3 the UE transmits its identifier, UE ID, or more exactly the initial part of the 5G Temporary Mobile Subscriber Identity (5G-TMSI) for initial access or if it is already in RRC_CONNECTED or RRC_INACTIVE state and needs to e.g. re-synchronize, its UE-specific RNTI.

If the gNB cannot decode Msg3 at the granted UL resources, it may send a Downlink Control Indicator (DCI) addressed to TC-RNTI for retransmission of Msg3. Hybrid Automatic Repeat Request (HARQ) retransmission is requested until the UEs restart the random access procedure from step 1 after reaching the maximum number of HARQ retransmissions or until Msg3 can be successfully received by the gNB.

### Step 4: Msg4 Contention Resolution

In Msg4 the gNB responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously.

For Msg4 reception, the UE monitors TC-RNTI (if it transmitted its UE ID in Msg3) or C-RNTI (if it transmitted its C-RNTI in Msg3).

### 2-Step RA Type

The 2-step RA type gives much shorter latency than the ordinary 4-step RA. In the 2-step RA the preamble and a message corresponding to Msg3, MsgA PUSCH, in the 4-step RA can, depending on configuration, be transmitted in two subsequent slots. The MsgA PUSCH is sent on a resource dedicated to the specific preamble. The 2-step RA procedure is depicted a signalling diagram illustrating signalling between a UE and a gNB of FIG. 2.

Upon successful reception of MsgA, the gNB will respond with a message B (MsgB). The MsgB may be either a “successRAR”, “fallbackRAR, or “Back off”. The content of MsgB has been agreed as seen below. It is noted in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

The possibility to replace the 4-step message exchange by a 2-step message exchange would lead to reduced RA latency. On the other hand, the 2-step RA will consume more resources since it uses contention-based transmission of the data. This means that the resources that are configured for the data transmission may often be unused. Another difference is that 2-step RA operated without a TA since there is no feedback from gNB on how to adjust the uplink synchronization before the data payload is transmitted in MsgA PUSCH. Effectively TA is zero for 2-step RA and therefore the solution is restricted to use in cell of smaller size, whereas 4-step RA can operate in any cell size.

If both the 4-step and 2-step RA are configured in a cell on shared PRACH resources, and for the UE, the UE will choose its preamble from one specific set if the condition of 4-step RA is met, and from another set if the condition of 2-step RA, based on the measured RSRP, is met. Hence a preamble partition is done to distinguish between 4-step and 2-step RA when shared PRACH resources are used. Alternatively, the PRACH configurations are different for the 2-step and 4-step RA procedure, in which case it can be deduced from where the preamble transmission is done if the UE is doing a 2-step or

4-Step Procedure.

4-step RA SDT When the 4-step RA is applied for SDT, the Msg3 will contain a RRC Resume Request (RRCResumeRequest) message and UP data. The gNB will, as in the legacy case, respond with the Contention Resolution (CR)-Identifier (ID) to resolve contention and at this point, the TC-RNTI will be used by the UE as C-RNTI, i.e. the UE will monitor PDCCH for DCI scrambled by C-RNTI to obtain new UL grants, in case subsequent transmissions are needed. The SDT procedure ends when the gNB sends a RRCRelease with suspend config message and thereby keeping the UE in Inactive state. Alternatively, the gNB may instead send an RRCResume message and move the UE to a connected state.

### 2-Step RA SDT

When the 2-step RA is applied for SDT, the MsgA will contain the RRCResumeRequest message and UP data. The gNB will as in the legacy case respond with the CR-ID to resolve contention. It will also send a C-RNTI and the UE will monitor PDCCH for DCI scrambled by C-RNTI to obtain new UL grants, in case subsequent transmissions are needed. As for the 4-step procedure, the SDT procedure ends when the gNB sends a RRCRelease with a suspend config message and thereby keeping the UE in inactive state. Alternatively, the gNB may instead send an RRCResume message and move the UE to connected state.

Power Headroom Report (PHR) procedure

A PHR procedure is used for UEs in connected state to report the available power the UE has, i.e. the difference between nominal maximum power and the estimated used power. PHR when used herein may also be referred to as PHR MAC Control Element (CE). The PHR is valuable for the gNB to enable efficient power control and link adaptation, ensuring that the UE can reach as high bitrate as possible. The PHR procedure is described in Section 5.6.2 in 38.321 as follows below.

The Power Headroom reporting procedure is used to provide the serving gNB with the following information:
Type 1 power headroom: the difference between the nominal UE maximum transmit power and the estimated power for UL Shared Channel (UL-SCH) transmission per activated serving cell;
Type 2 power headroom: the difference between the nominal UE maximum transmit power and the estimated power for UL-SCH and PUCCH transmission on SpCell of the other MAC entity, i.e. Evolved Universal Terrestrial Radio Access (E-UTRA) MAC entity in E-UTRA NR-Dual Connectivity (EN-DC), New Radio E-UTRA-Dual Connectivity (NE-DC), and NGEN-DC cases;
Type 3 power headroom: the difference between the nominal UE maximum transmit power and the estimated power for Sounding Reference Signal (SRS) transmission per activated Serving Cell.

RRC controls Power Headroom reporting by configuring the following parameters:
phr-PeriodicTimer;
phr-ProhibitTimer;
phr-Tx-PowerFactorChange;
phr-Type2OtherCell;
phr-ModeOtherCG; and
multiplePHR.

A PHR shall be triggered if any of the following events occur:
phr-ProhibitTimer expires or has expired and the path loss has changed more than phr-Tx-PowerFactorChange dB for at least one activated Serving Cell of any MAC entity of which the active DL BWP is not dormant BWP which is used as a pathloss reference since the last transmission of a PHR in this MAC entity when the MAC entity has UL resources for new transmission.

Note 1: The path loss variation for one cell assessed above is between the pathloss measured at present time on the current pathloss reference and the pathloss measured at the transmission time of the last transmission of PHR on the pathloss reference in use at that time, irrespective of whether the pathloss reference has changed in between. The current pathloss reference for this purpose does not include any pathloss reference configured using pathlossReferenceRS-Pos in TS 38.331.
phr-PeriodicTimer expires;
upon configuration or reconfiguration of the power headroom reporting functionality by upper layers, which is not used to disable the function;
activation of an SCell of any MAC entity with configured uplink of which firstActiveDownlinkBWP-Id is not set to dormant BWP;
addition of the PSCell, i.e. PSCell is newly added or changed;
phr-ProhibitTimer expires or has expired, when the MAC entity has UL resources for new transmission, and the following is true for any of the activated Serving Cells of any MAC entity with configured uplink:
there are UL resources allocated for transmission or there is a PUCCH transmission on this cell, and the required power backoff due to power management as allowed by Power Management Maximum Power (P-MPR), as specified in TS 38.101-1, TS 38.101-2, and TS 38.101-3, for this cell has changed more than phr-Tx-PowerFactorChange dB since the last transmission of a PHR when the MAC entity had UL resources allocated for transmission or PUCCH transmission on this cell.
Upon change of activated BWP from dormant BWP to non-dormant DL BWP of an SCell of any MAC entity with configured uplink.

Note 2: The MAC entity should avoid triggering a PHR when the required power backoff due to power management decreases only temporarily (e.g. for up to a few tens of milliseconds) and it should avoid reflecting such temporary decrease in the values of PCMAX,f,c/PH when a PHR is triggered by other triggering conditions.

Note 3: If a HARQ process is configured with cg-RetransmissionTimer and if the PHR is already included in a MAC Protocol Data Unit (PDU) for transmission by this HARQ process, but not yet transmitted by lower layers, it is up to UE implementation how to handle the PHR content.

If the MAC entity has UL resources allocated for a new transmission the MAC entity shall:
1> if it is the first UL resource allocated for a new transmission since the last MAC reset:
   2> start phr-PeriodicTimer;
1> if the Power Headroom reporting procedure determines that at least one PHR has been triggered and not cancelled; and
1> if the allocated UL resources can accommodate the MAC CE for PHR which the MAC entity is configured to transmit, plus its subheader, as a result of LCP as defined in clause 5.4.3.1:
   2> if multiplePHR with value true is configured:
      3> for each activated Serving Cell with configured uplink associated with any MAC entity of which the active DL BWP is not dormant BWP:
         4> obtain the value of the Type 1 or Type 3 power headroom for the corresponding uplink carrier as specified in clause 7.7 of TS 38.213 for NR Serving Cell and clause 5.1.1.2 of TS 36.213 for E-UTRA Serving Cell;
         4> if this MAC entity has UL resources allocated for transmission on this Serving Cell; or
         4> if the other MAC entity, if configured, has UL resources allocated for transmission on this Serving Cell and phr-ModeOtherCG is set to real by upper layers:
         5> obtain the value for the corresponding PCMAX,f,c field from the physical layer.
      3> if phr-Type2OtherCell with value true is configured:
         4> if the other MAC entity is E-UTRA MAC entity:
         5> obtain the value of the Type 2 power headroom for the SpCell of the other MAC entity, i.e. E-UTRA MAC entity;
         5> if phr-ModeOtherCG is set to real by upper layers:
         6> obtain the value for the corresponding PCMAX,f,c field for the SpCell of the other MAC entity, i.e. E-UTRA MAC entity, from the physical layer.
      3> instruct the Multiplexing and Assembly procedure to generate and transmit the Multiple Entry PHR MAC CE as defined in clause 6.1.3.9 based on the values reported by the physical layer.
   2> else i.e. Single Entry PHR format is used:
      3> obtain the value of the Type 1 power headroom from the physical layer for the corresponding uplink carrier of the PCell;
      3> obtain the value for the corresponding PCMAX,f,c field from the physical layer;
      3> instruct the Multiplexing and Assembly procedure to generate and transmit the Single Entry PHR MAC CE as defined in clause 6.1.3.8 based on the values reported by the physical layer.
   2> start or restart phr-PeriodicTimer;
   2> start or restart phr-ProhibitTimer;
   2> cancel all triggered PH R(s).”

For SDT, it may be assumed that only Type 1 power headroom will be used, since SDT will not be defined for Dual Connectivity (DC), where Type 2 may be applied, and since it is used in inactive state, there will not be any SRS transmissions, when Type 3 may be applied.

### SUMMARY

As a part of developing embodiments herein the inventors identified a problem which first will be discussed.

The PHR procedure is only defined for use in connected state, e.g. RRC_CONNECTED. Hence, there is currently no way to use PHR when in inactive state, e.g. RRC_INACTIVE.

In some scenarios, the inclusion of a PHR when being in an inactive state may however be important, e.g. to enable a large grant. This is since, if there is sufficient power left in the UE, it may be possible to minimize the number of subsequent transmissions needed for the SDT procedure. The SDT procedure in Inactive mode is only efficient if the number of transmissions needed is small. In case the number of needed transmissions is larger, it is more efficient to move to Connected mode and perform the transmissions there. However, transmitting PHR in inactive state, may be wasteful as there may not be any subsequent transmission for inactive state.

Another problem that arises is that, since the grants given in a SDT procedure is typically small, the current PHR format is not efficient and need to be minimized.

An object of embodiments herein is to improve the efficiency of small data transmissions.

According to an aspect, the object is achieved by a method performed by a User Equipment, UE. The method is for handling a Power Headroom Report, PHR, in a Small Data Transmission, SDT, to a network node in a wireless communications network. The UE is in a Radio Resource Control, RRC, inactive state. The UE obtains buffer status information related to a data volume for a SDT comprised in a buffer in the UE. When the data volume for an SDT to be transmitted to the network node requires at least one transmission after a Random Access, RA, procedure, according to the buffer status information, the UE triggers a PHR. The PHR is to be transmitted to the network node.

According to another aspect, the object is achieved by a method performed by a network node. The method is for handling a Small Data Transmission, SDT, from a User Equipment, UE in a wireless communications network. The UE is in an Radio Resource Control, RRC, inactive state.

When the data volume for an SDT to be transmitted to the network node requires at least one transmission outside a Random Access, RA, procedure, the network node receives a Power Headroom Report, PHR, from the UE.

The network node then handles a part of the data volume of the SDT that is to be transmitted after the RA based on the PHR.

According to an aspect, the object is achieved by a User Equipment, UE configured to handle a Power Headroom Report, PHR, during a Small Data Transmission, SDT, to a network node in a wireless communications network. The UE is adapted to be in an Radio Resource Control, RRC, inactive state. The UE is further configured to:
Obtain buffer status information related to a data volume for a SDT comprised in a buffer in the UE, and
when the data volume for an SDT to be transmitted to the network node is adapted to require at least one transmission after a Random Access, RA, procedure according to the buffer status information, trigger a PHR, which PHR is to be transmitted to the network node.

According to another aspect, the object is achieved by a network node configured to handle a Small Data Transmission, SDT, from a User Equipment, UE in a wireless communications network. The UE is adapted to be in a Radio Resource Control, RRC, inactive state. The network node is further configured to:
When the data volume for an SDT to be transmitted to the network node is adapted to require at least one transmission outside a Random Access, RA, procedure, receive a Power Headroom Report, PHR, from the UE, and
handle a part of the data volume of the SDT that is adapted to be to be transmitted after the RA based on the PHR.

Thanks to that the UE triggers a PHR according to the buffer status information when the data volume for the SDT requires at least one transmission after the RA procedure, link adaptation and power control will be more efficient when subsequent transmissions are needed. In this way, the PHR procedure is defined in an efficient way for the SDT procedure.

An advantage of embodiments herein is that the PHR report is not transmitted in the case it is not needed due to that the data transmission will only need one transmission. That is, the PHR is useful in case there would be subsequent transmissions and this embodiment ensures that PHR is not transmitted when there are no subsequent transmissions.

### BRIEF DESCRIPTION OF THE DRAWINGS

FIG. 1 is a signaling diagram depicting an example of prior art.

FIG. 2 is a signaling diagram depicting an example of prior art.

FIG. 3 is a schematic block diagram depicting embodiments of a wireless communication network.

FIG. 4 is a flow chart depicting embodiments of a method in a UE.

FIG. 5 is a flow chart depicting embodiments of a method in a network node.

FIGS. 6 a and b are schematic block diagrams depicting embodiments of a UE.

FIGS. 7 a and b are schematic block diagrams depicting embodiments of a network node.

FIG. 8 schematically illustrates a telecommunication network connected via an intermediate network to a host computer.

FIG. 9 is a generalized block diagram of a host computer communicating via a base station with a user equipment over a partially wireless connection.

FIGS. 10 to 13 are flowcharts illustrating methods implemented in a communication system including a host computer, a base station and a user equipment.

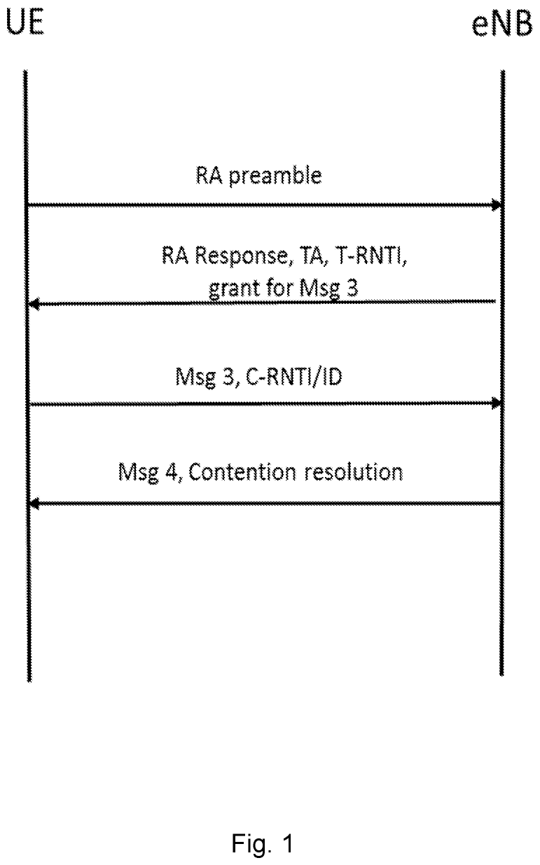

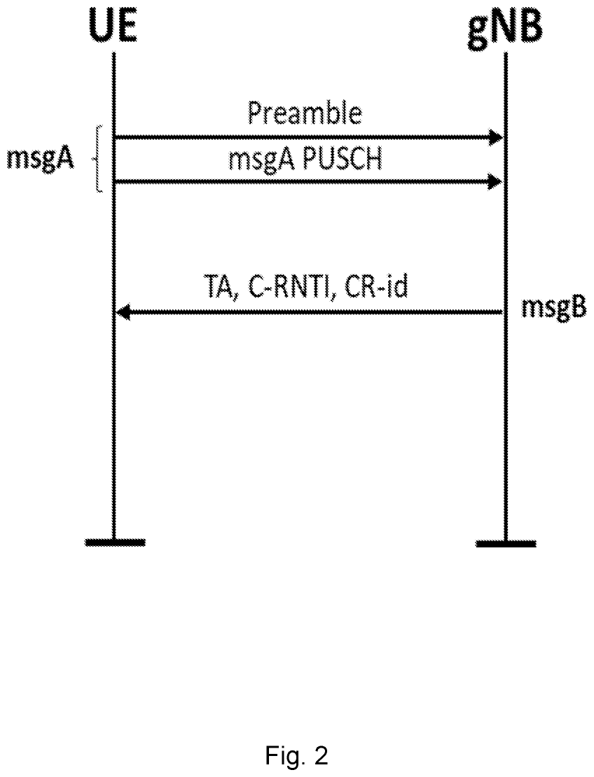

### DETAILED DESCRIPTION

As mentioned above the object of embodiments herein is to improve the efficiency of SDT.

In some example embodiments, the object is achieved by triggering a PHR during an SDT procedure in scenarios when there will be at least one subsequent transmission. A data volume threshold may be defined. The PHR is triggered to be included in a UL transmission, when data in the UEs buffer upon initialization of the SDT procedure exceeds the data volume threshold. In this way link adaptation and power control will be more efficient when subsequent transmissions are needed.

In some embodiments, the PHR may be triggered but not transmitted during the SDT procedure, until one or more criteria has been met. In this way the actual transmission will be optimized so that if it is not needed in the first message it may be postponed to a later transmission.

Furthermore, in some embodiments a format of the PHR to be used in an SDT procedure is defined, e.g. to a smaller format than the legacy PHR. The smaller format may e.g. be to code only a few levels of power headroom or coding it utilizing unused Logical Channel ID (LCID) or extended Logical Channel ID (eLCID) values. Alternatively, or additionally, the format of the PHR may be combined with a Buffer Status Report (BSR). In this way a more efficient format for transmitting PHR is achieved.

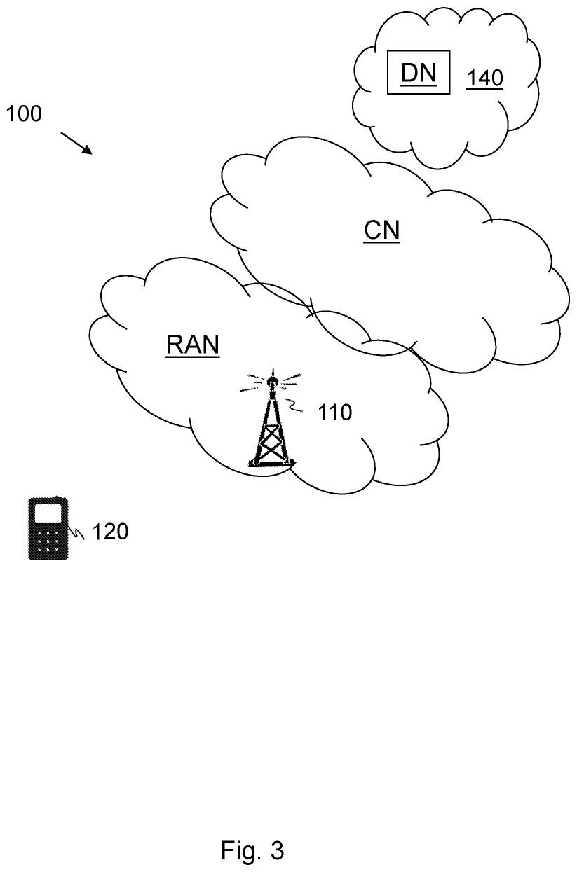

FIG. 3 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100, by means of antenna beams, referred to as beams herein. The network node 110 e.g. provides a number of cells referred to as cell1 and cell2, and may use these cells for communicating with e.g. a UE 120. The network node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used.

User Equipments operate in the wireless communications network 100, such as a UE 120. The UE 120 may e.g. be an NR device, a mobile station, a wireless terminal, an NB-IoT device, an enhanced Machine Type Communication (eMTC) device, an NR Reduced Capability (RedCap) device, a Category M (CAT-M) device, a Wi-Fi device, an LTE device and a non-access point (non-AP) STA, a STA, that communicates via a base station such as e.g. the network node 110, one or more Access Networks (AN), e.g. RAN, to one or more CNs. It should be understood by the skilled in the art that the UE relates to a non-limiting term which means any UE, terminal, wireless communication terminal, user equipment, Device to Device (D2D) terminal, or node e.g. smart phone, laptop, mobile phone, sensor, relay, mobile tablets or even a small base station communicating within a cell.

Methods herein may in one aspect be performed by the network node 110, in another aspect by the UE 120. As an alternative, a Distributed Node (DN) and functionality, e.g. comprised in a cloud 140 as shown in FIG. 3, may be used for performing or partly performing the methods.

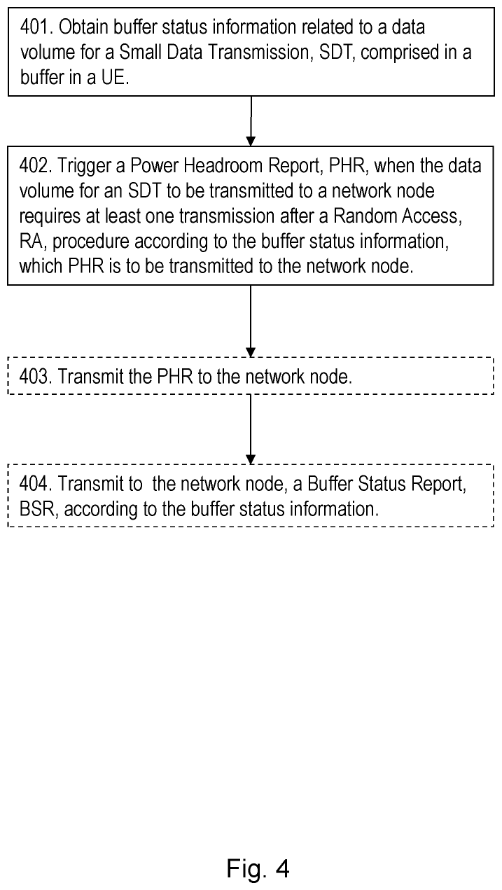

FIG. 4 shows an example method performed by the UE 120, for handling a PHR during an SDT to the network node 110 in the wireless communications network 100. The handling of the PHR may e.g. comprise managing the PHR. During the SDT may e.g. relate to during an SDT procedure. The UE 120 is in an RRC inactive state.

The method comprises any one or more out of the actions below.

### Action 401

According to an example scenario, the UE 120 has data for STD in its buffer and is about to start a random access to the network node 110.

The UE 120 obtains buffer status information related to a data volume for a SDT comprised in a buffer in the UE 120.

This may be to find out if the data volume, e.g. comprised in the buffer of the UE 120, does not go in to be sent within the RA procedure, but some further transmissions are required after the RA procedure. E.g. if there only is a small data volume, it goes in to be sent within the RA procedure.

### Action 402

When the data volume for an SDT to be transmitted to the network node 110 requires at least one transmission after an RA procedure according to the buffer status information, the UE 120 triggers a PHR. This may mean that the data volume is not small enough to go in to be sent within the RA procedure. The PHR is to be transmitted to the network node 110. It may be sent directly or after a while.

This may mean that if the data volume is small enough to be sent within the RA procedure, no PHR will be transmitted at this moment.

In some embodiments, the UE 120 triggers the PHR to the network node 110 when any one or more first criteria are met, e.g., when the data volume exceeds a threshold. The PHR may e.g., be triggered when the buffer status information is outside an available grant size for message 3 of the RA procedure.

### Action 403

The UE 120 may then transmit the PHR to the network node 110. The PHR may be used by the network node 110 to efficiently do link adaptation and power control.

In some embodiments, the UE 120 transmits the PHR to the network node 110 when a second criterion is met. The second criterion may also be referred to as one or more second criteria. The one or more second criteria may e.g., be when the data volume exceeds a threshold.

### Action 404

The UE 120 may transmit a BSR to the network node 110. The BSR is according to the buffer status information. The BSR may e.g. be transmitted separately or together with the PHR in Action 403.

This may mean that the UE 120 will transmit the part of the data volume that goes in to the RA, in a RA message to the network node 110. Then the rest of the data may be transmitted by the UE 120 after the network node 110 has handled the part of the data volume of the SDT that is to be transmitted after the RA based on the PHR, e.g., performed link adaptation and power control based on the PHR.

In this way the UE 120 transmits the information which is most important to enable efficient link adaptation and power control. I.e., the UE 120 transmits the most important information to enable efficient link adaptation and power control. Most important information may e.g., mean the PHR and BSR.

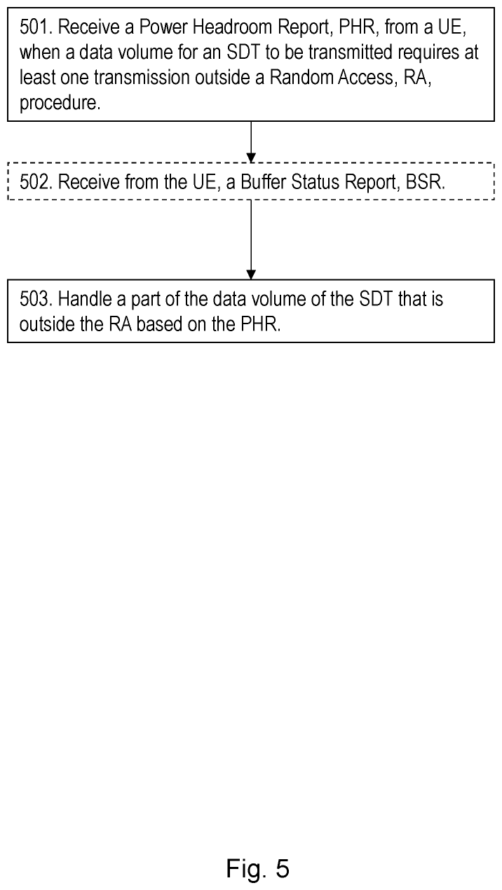

FIG. 5 shows an example method performed by the network node 110 e.g. for handling, such as managing, an SDT from the UE 120 in the wireless communications network 100. The UE 120 is in an RRC inactive state.

The method comprises any one or more out of the actions below.

### Action 501

The network node 110 receives a PHR from the UE 120. This may be the PHR transmitted by the UE 120 in Action 403. The PHR is received when a data volume for an SDT to be transmitted to the network node 110 requires at least one transmission outside, e.g., after a RA procedure. To be outside an RA procedure e.g. means that the data volume exceeds an available grant size for message 3.

This may mean that if the data volume is small enough to be sent within the RA procedure, no PHR will be received from the UE 120 at this moment.

In some embodiments, the network node 110 receives the PHR when one or more second criteria is met. The one or more second criteria may e.g. be when the data volume exceeds a threshold.

### Action 502

In some embodiments, the network node 110 receives a BSR from the UE 120.

The BSR is according to a buffer status information relating to the data volume for the SDT to be transmitted to the network node 110. This means that the BSR relates to the data volume for the SDT to be transmitted to the network node 110. The BSR from the UE 120 will be used for determining the size of the grant given to the UE 120 for subsequent transmission(s).

This may be the BSR transmitted by the UE 120 in Action 402, or 403. The BSR may e.g., be received separately or together with the PHR, in Action 501.

### Action 503

The network node 110 handles the part of the data volume of the SDT that is to be transmitted after the RA based on the PHR.

The handing may be for handling and/or managing power control and link adaptation based on the PHR.

In this way the network node 110 may ensure that the link adaptation and power control is done in an efficient way for the subsequent transmissions in the SDT procedure.

The method will now be further explained and exemplified in below embodiments. These below embodiments may be combined with any suitable embodiment as described above.

Several embodiments are provided herein, providing to trigger 402 and transmit 403 a PHR during an SDT procedure. Further, some embodiments of a new PHR format for the PHR MAC CE and the corresponding multiplexing in MAC for transmission are provided.

Herein, a PHR triggered 402 by the UE 120, may comprise:
i) Obtaining a power headroom value from a physical layer for a corresponding uplink carrier and a corresponding configured maximum output Power (Pcmax) and
ii) generating PHR MAC CE and multiplexing into a MAC PDU for transmission.
i) and ii) may be combined or performed at separate time instances depending on the solution.

In some embodiments, a PHR is triggered 402 by the UE 120 when an SDT is initiated and the available UL data in DRBs configured for SDT is above a threshold e.g. an SDT_PHR_Threshold, i.e. one or more a first and/or second criteria are met. The SDT_PHR_Threshold is also referred to as the threshold.

In some options, the SDT_PHR_Threshold may be equivalent to the msgA PUSCH size for a 2-step RA procedure or the RA-Msg3 Size Group A (ra-Msg3SizeGroupA) used for a 4-step RA procedure.

In some options, the PHR is triggered 402 if available UL data in DRBs configured for SDT is above either of the msgA PUSCH size for a 2-step RA procedure or the ra-Msg3SizeGroupA used for a 4-step RA procedure, i.e. one or more a first and/or second criteria are met.

In some options, the PHR is triggered 402 if available UL data in DRBs configured for SDT is above both of the msgA PUSCH size for a 2-step RA procedure or the ra-Msg3SizeGroupA used for a 4-step RA procedure, i.e. one or more a first and/or second criteria are met.

In some options, in case a PHR is triggered 402 and the 4-step RA procedure is selected in the SDT procedure, the PHR MAC CE is included in Msg3, when transmitting 403 the PHR to the network node 110.

In some options, in case a PHR is triggered 402 and the 2-step RA procedure is selected in the SDT procedure, the PHR MAC CE is included in MsgA, when transmitting 403 the PHR to the network node 110.

In some options, when the 4-step RA procedure is selected in the SDT procedure, the PHR MAC CE is always included in Msg3, when transmitting 403 the PHR to the network node 110.

In some options, when the 2-step RA procedure is selected in the SDT procedure, the PHR MAC CE is always included in MsgA, when transmitting 403 the PHR to the network node 110.

In some other embodiments, when CG-SDT resources are available, the PHR is triggered 402 during an ongoing SDT procedure if available UL data in DRBs configured for SDT is above the grant size for a CG transmission occasion i.e. one or more a first and/or second criteria are met.

In some other options, when CG-SDT resources are available, the PHR is triggered 402 if the CG periodicity is below or above an SDT_PHR_CG periodicity_Threshold, also referred to as the threshold, i.e. one or more a first and/or second criteria are met.

In some other options, when CG-SDT resources are available, the PHR is included in the first CG transmission, when transmitting 403 the PHR to the network node 110.

In some other options, when CG-SDT resources are available, the PHR is included in the first CG transmission after the CG transmission containing the RRCResumeRequest message.

In some other options, separate thresholds, e.g. SDT_PHR_Threshold may be configured for SDT based on 2-step RA, for SDT based on 4 step RA, and for CG-SDT.

In one embodiment, the thresholds such as SDT_PHR_Threshold and SDT_PHR_CG periodicity_Threshold are included in system information (SI).

In another option, the thresholds such as SDT_PHR_Threshold and SDT_PHR_CG periodicity_Threshold are included in dedicated RRC signalling.

In some embodiments, it is configured in SI if PHR is applied to SDT. This may include the case when the PHR MAC CE is always transmitted 403 and the case when it is triggered 402.

In some embodiments, the network node 110, e.g. a gNB, response RRCResume may include an indication that the next UL transmission should contain a PHR MAC CE.

In another option, the network node 110, e.g. a gNB, response RRCResume will trigger 402 the next possible UL transmission to contain a PHR MAC CE.

In some embodiments, a triggered 402 PHR is reported, e.g. transmitted 403, as an N level power headroom using reserved or available otherwise bits in another MAC CE. For example, a 2-bit/bit-map field in a BSR indicating 4 levels. This may be indicated by a specific LCID or eLCID, or alternatively always used (i.e. may be fixed format).

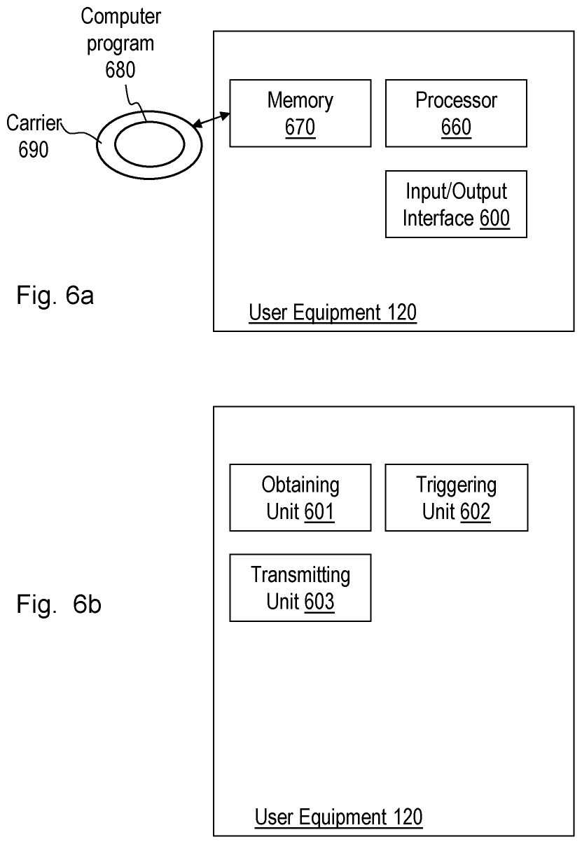

FIGS. 6a and 6b shows an example of arrangement in the UE 120.

The UE 120 may comprise an input and output interface 600 configured to communicate with each other. The input and output interface 600 may comprise a receiver, e.g. wired and/or wireless, (not shown) and a transmitter, e.g. wired and/or wireless, (not shown).

The UE 120 may comprise any one or more out of: An obtaining unit 601, a triggering unit 602, and a transmitting unit 603 to perform the method actions as described herein.

The embodiments herein may be implemented through a respective processor or one or more processors, such as at least one processor 660 of a processing circuitry in the UE 120 depicted in FIG. 6a, together with computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise respective a memory 670 comprising one or more memory units. The memory 670 comprises instructions executable by the processor in the UE 120.

The memory 670 is arranged to be used to store instructions, data, configurations, and applications to perform the methods herein when being executed in the UE 120.

In some embodiments, a computer program 680 comprises instructions, which when executed by the at least one processor 660, cause the at least one processor 860 of the UE 120 to perform the actions above.

In some embodiments, a respective carrier 670 comprises the respective computer program 680, wherein the carrier 670 is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 120, described below may refer to a combination of analog and digital circuits, and/or one or more processors configured with software and/or firmware, e.g. stored in the UE 120, that when executed by the respective one or more processors such as the at least one processor 660 described above cause the respective at least one processor 660 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

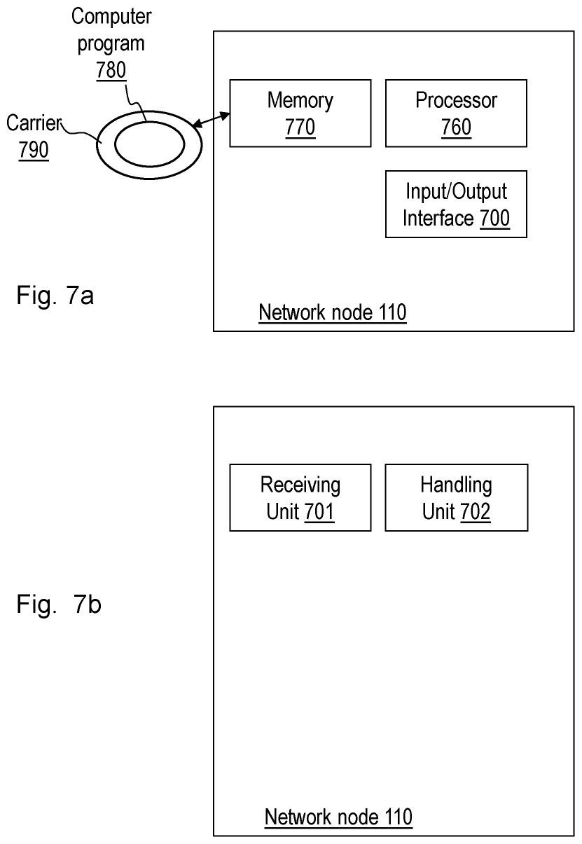

FIGS. 7a and 7b shows an example of arrangement in the network node 110.

The network node 110 may comprise an input and output interface 700 configured to communicate with each other. The input and output interface 700 may comprise a receiver, e.g. wired and/or wireless, (not shown) and a transmitter, e.g. wired and/or wireless, (not shown).

The network node 110 may comprise any one or more out of: A receiving unit 701, and a handling unit 702 to perform the method actions as described herein.

The embodiments herein may be implemented through a respective processor or one or more processors, such as at least one processor 760 of a processing circuitry in the network node 110 depicted in FIG. 7a, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise respective a memory 770 comprising one or more memory units. The memory 770 comprises instructions executable by the processor in the network node 110.

The memory 770 is arranged to be used to store instructions, data, configurations, and applications to perform the methods herein when being executed in the network node 110.

In some embodiments, a computer program 780 comprises instructions, which when executed by the at least one processor 760, cause the at least one processor 760 of the network node 110 to perform the actions above.

In some embodiments, a respective carrier 770 comprises the respective computer program 780, wherein the carrier 770 is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analog and digital circuits, and/or one or more processors configured with software and/or firmware, e.g. stored in the network node 110, that when executed by the respective one or more processors such as the at least one processor 760 described above cause the respective at least one processor 760 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Below, some example embodiments 1-22 are shortly described. See e.g. FIGS. 4, 5, 6a, 6b, 7a, and 7b.

Embodiment 1. A method performed by a User Equipment, UE 120, e.g. for handling, such as managing, a Power Headroom Report, PHR, in, such as e.g. during a Small Data Transmission, SDT, e.g. procedure to a network node 110 in a wireless communications network 100, which UE 120 is in a Radio Resource Control, RRC, inactive state, the method comprising any one or more out of:
obtaining 401 buffer status information related to a data volume for a SDT comprised in a buffer in the UE 120,
when the data volume for an SDT to be transmitted to the network node 110 requires at least one transmission after a Random Access, RA, procedure, according to the buffer status information, e.g. is outside the available grant size for message 3, triggering 402 a PHR, which PHR is to be transmitted to the network node 110.

Embodiment 2. The method according to Embodiment 1, further comprising: transmitting 403 the PHR to the network node 110.

Embodiment 3. The method according to Embodiment 2, wherein the transmitting 403 the PHR to the network node 110, is performed when a second criterion is met.

Embodiment 4. The method according to any of the Embodiments 2-3, wherein:
transmitting 404 to the network node 110, a Buffer Status Report, BSR, according to the buffer status information, e.g. together with the PHR 403.

Embodiment 5. The method according any of the Embodiments 1-4, wherein:
the triggering 402 of the PHR to the network node 110, is performed when any one or more first criteria are met.

Embodiment 6. The method according to any of the Embodiments 1-5, wherein the triggering 402 of the PHR is performed when the data volume exceeds a threshold.

Embodiment 7. A computer program 680 comprising instructions, which when executed by a processor 660, causes the processor 660 to perform actions according to any of the Embodiments 1-6.

Embodiment 8. A carrier 670 comprising the computer program 680 of Embodiment 7, wherein the carrier 670 is one of an electronic signal, an optical signal, an electromagnetic signal, a magnetic signal, an electric signal, a radio signal, a microwave signal, or a computer-readable storage medium.

Embodiment 9. A method performed by a network node 110 e.g. for handling, such as managing, a Small Data Transmission, SDT, from a User Equipment, UE 120 in a wireless communications network 100, which UE 120 is in an Radio Resource Control, RRC, inactive state, the method comprising any one or more out of:
when the data volume for an SDT to be transmitted to the network node 110 requires at least one transmission outside, e.g. after, a Random Access, RA, procedure, e.g. is outside the available grant size for message 3, receiving 501 a Power Headroom Report, PHR, from the UE 120,
handling 503 a part of the data volume of the SDT that is to be transmitted after the RA based on the PHR, e.g. for power control and link adaptation.

Embodiment 10. The method according to Embodiment 2, wherein the PHR is received 501 when one or more second criteria is met, e.g. when the data volume exceeds a threshold.

Embodiment 11. The method according to any of the Embodiments 2-3, wherein:
receiving 502 from the UE 120, a Buffer Status Report, BSR, e.g. together with the PHR 501.

Embodiment 12. A computer program 780 comprising instructions, which when executed by a processor 760, causes the processor 760 to perform actions according to any of the Embodiments 9-11.

Embodiment 13. A carrier 770 comprising the computer program 780 of Embodiment 7, wherein the carrier 770 is one of an electronic signal, an optical signal, an electromagnetic signal, a magnetic signal, an electric signal, a radio signal, a microwave signal, or a computer-readable storage medium.

Embodiment 14. A User Equipment, UE 120, e.g. configured to handle, such as manage, a Power Headroom Report, PHR, during a Small Data Transmission, SDT, e.g. procedure to a network node 110 in a wireless communications network 100, which UE 120 is adapted to be in an Radio Resource Control, RRC, inactive state, the UE 120 further being configured to any one or more out of:
obtain buffer status information related to a data volume for a SDT comprised in a buffer in the UE 120, e.g. by means of an obtaining unit 601,
when the data volume for an SDT to be transmitted to the network node 110 is adapted to require at least one transmission after a Random Access, RA, procedure according to the buffer status information, e.g. is adapted to be outside the available grant size for message 3, trigger a PHR, which PHR is to be transmitted to the network node 110, e.g. by means of an triggering unit 602.

Embodiment 15. The UE 120 according to Embodiment 14, further being configured to:
transmit, e.g. by means of a transmitting unit 603, the PHR to the network node 110.

Embodiment 16. The UE 120 according to Embodiment 15 further configured to transmit, e.g. by means of the transmitting unit 603, the PHR to the network node 110 when one or more second criteria is met.

Embodiment 17. The UE 120 according to any of the Embodiments 15-16 further configured to transmit, to the network node 110, e.g. by means of the transmitting unit 603, a Buffer Status Report, BSR, according to the buffer status information, e.g. by transmitting the BSR together with the PHR.

Embodiment 18. The UE 120 according to any of the Embodiments 14-17 further configured to trigger the PHR when any one or more first criteria are met, e.g. by means of the triggering unit 602.

Embodiment 19. The UE 120 according to any of the Embodiments 14-18 further configured to trigger, e.g. by means of the triggering unit 602, the PHR when the data volume exceeds a threshold.

Embodiment 20. A network node 110 e.g. configured to handle, such as manage, a Small Data Transmission, SDT, from a User Equipment, UE 120 in a wireless communications network 100, which UE 120 is adapted to be in an Radio Resource Control, RRC, inactive state, the network node 110 further being configured to any one or more out of:
when the data volume for an SDT to be transmitted to the network node 110 is adapted to require at least one transmission outside, e.g. after, a Random Access, RA, procedure, e.g. is adapted to be outside the available grant size for message 3, receive a Power Headroom Report, PHR, from the UE 120, e.g. by means of a receiving unit 701, and
handle, a part of the data volume of the SDT that is adapted to be to be transmitted after the RA based on the PHR, e.g. for power control and link adaptation e.g. by means of a handling unit 702.

Embodiment 21. The network node 110 according to Embodiment 20 further being configured to receive, the PHR when a second criterion is met, e.g. when the data volume exceeds a threshold e.g. by means of the receiving unit 701.

Embodiment 22. The network node 110 according to any of the Embodiments 20-21, further being configured to receive, a Buffer Status Report, BSR, e.g. by receiving the BSR together with the PHR e.g. by means of the receiving unit 701.

### FURTHER EXTENSIONS AND VARIATIONS

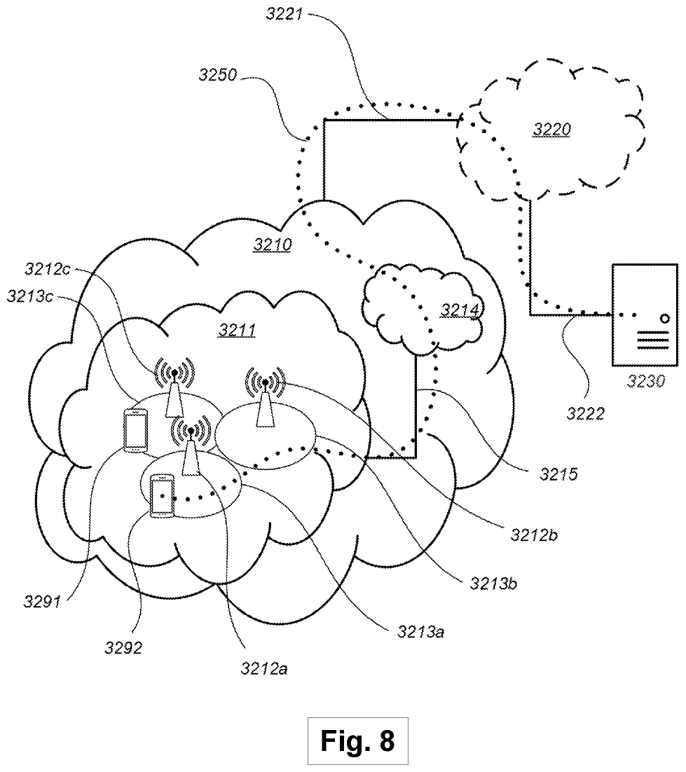

With reference to FIG. 8, in accordance with an embodiment, a communication system includes a telecommunication network 3210 such as the wireless communication network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

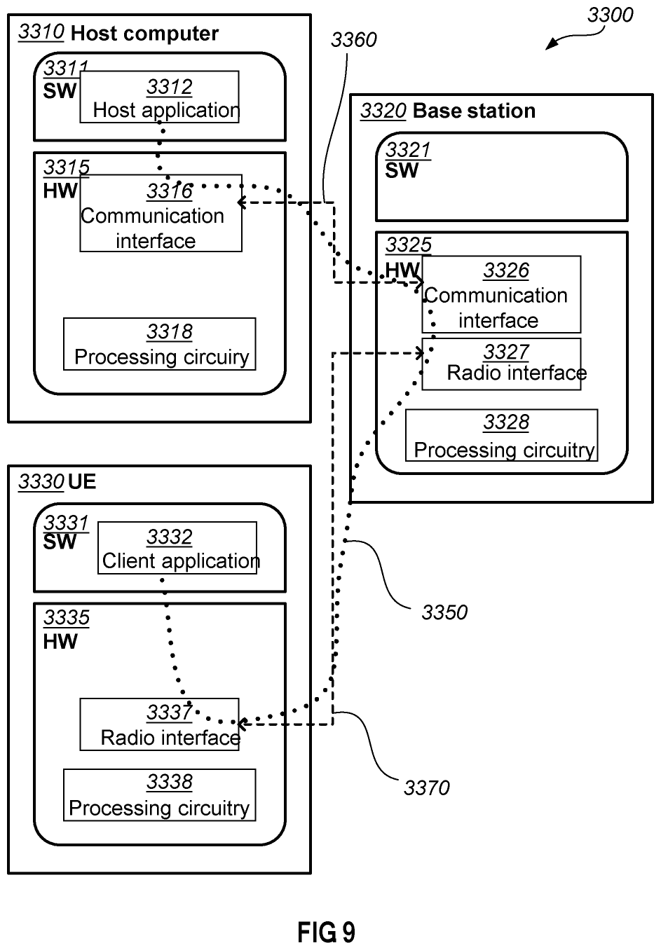

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

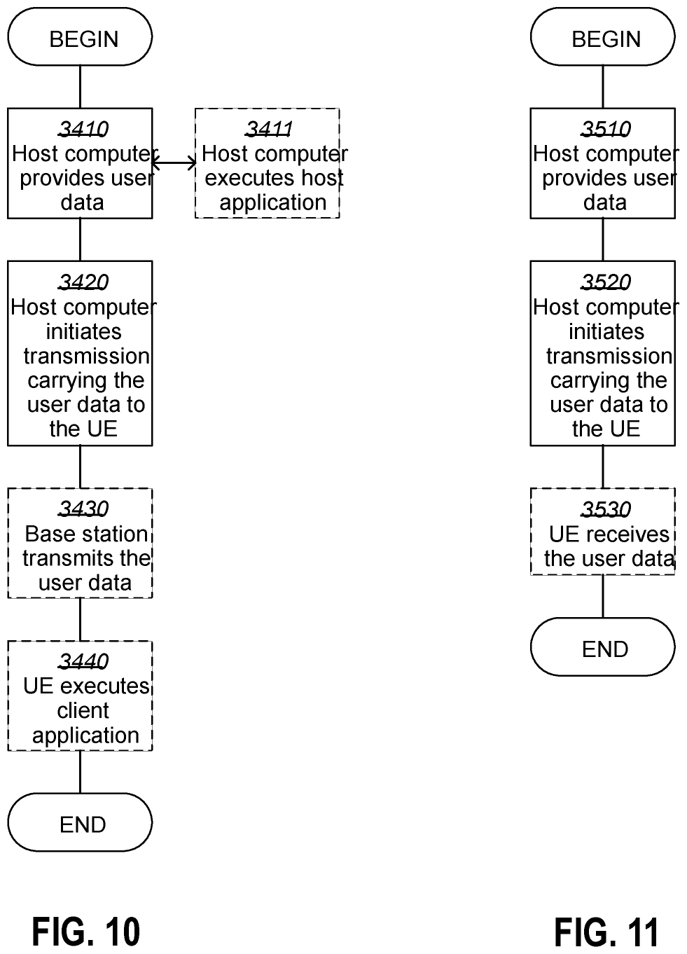

FIG. 10 is a flowchart illustrating a method implemented in a communication system, in accordance with one embodiment. The communication system includes a host computer, a base station such as the network node 112, and a UE such as the UE 120, which may be those described with reference to FIG. 9 and FIG. 8. For simplicity of the present disclosure, only drawing references to FIG. 10 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 8. For simplicity of the present disclosure, only drawing references to FIG. 11 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

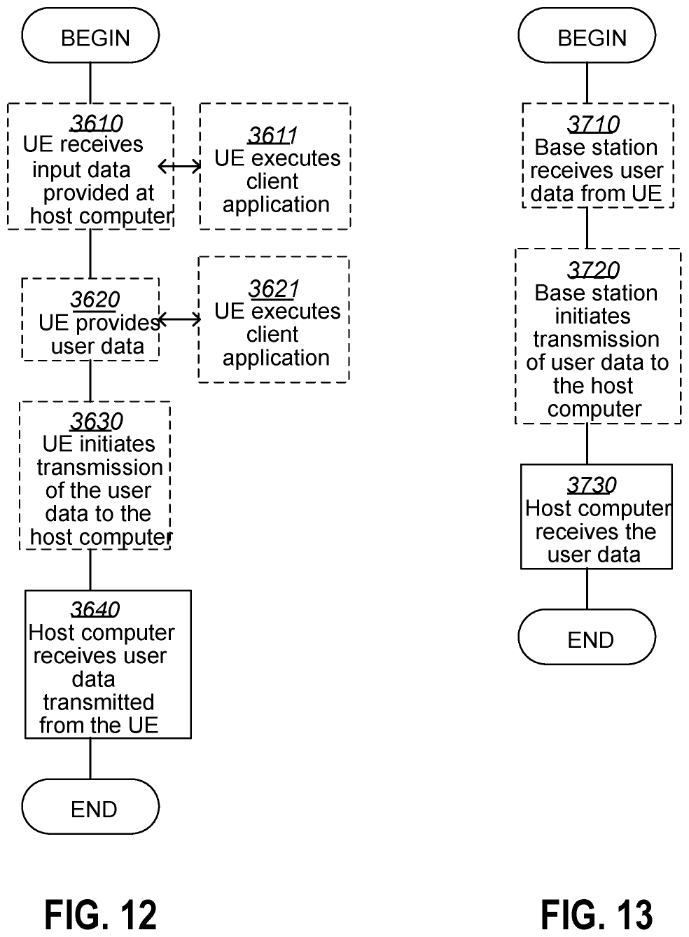

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 8. For simplicity of the present disclosure, only drawing references to FIG. 12 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 8. For simplicity of the present disclosure, only drawing references to FIG. 13 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1. A method performed by a User Equipment, UE for handling a Power Headroom Report, PHR, in a Small Data Transmission, SDT, to a network node in a wireless communications network, which UE is in a Radio Resource Control, RRC, inactive state, the method comprising:
obtaining buffer status information related to a data volume for a SDT comprised in a buffer in the UE; and
when the data volume for an SDT to be transmitted to the network node requires at least one transmission after a Random Access, RA, procedure according to the buffer status information, triggering a PHR, which PHR is to be transmitted to the network node.

2. The method according to claim 1, further comprising:
transmitting the PHR to the network node.

3. The method according to claim 2, wherein the transmitting the PHR to the network node, is performed when a second criterion is met.

4. The method according to claim 2, wherein:
transmitting to the network node, a Buffer Status Report, BSR, according to the buffer status information.

5. The method according to claim 1, wherein:
the triggering of the PHR to the network node, is performed when any one or more first criteria are met.

6. The method according to claim 1, wherein the triggering of the PHR is performed when the data volume exceeds threshold.

7. (canceled)

8. (canceled)

9. A method performed by a network node for handling a Small Data Transmission, SDT, from a User Equipment, UE in a wireless communications network, which UE is in an Radio Resource Control, RRC, inactive state, the method comprising:
when the data volume for an SDT to be transmitted to the network node requires at least one transmission outside a Random Access, RA, procedure, receiving a Power Headroom Report, PHR, from the UE; and
handling a part of the data volume of the SDT that is to be transmitted after the RA based on the PHR.

10. The method according to claim 9, wherein the PHR is received when one or more second criteria is met.

11. The method according to claim 9, wherein:
receiving from the UE, a Buffer Status Report, BSR, which BSR relates to the data volume for the SDT to be transmitted to the network node.

12. (canceled)

13. (canceled)

14. A User Equipment, UE configured to handle a Power Headroom Report, PHR, during a Small Data Transmission, SDT, to a network node in a wireless communications network, which UE is configured to be in an Radio Resource Control, RRC, inactive state, the UE further configured to:
obtain buffer status information related to a data volume for a SDT comprised in a buffer in the UE; and
when the data volume for an SDT to be transmitted to the network node is adapted to require at least one transmission after a Random Access, RA, procedure according to the buffer status information, trigger a PHR, which PHR is to be transmitted to the network node.

15. The UE according to claim 14, further configured to:
transmit the PHR to the network node.

16. The UE according to claim 15, further configured to transmit the PHR to the network node when one or more second criteria is met.

17. The UE according to claim 15, further configured to transmit, to the network node, a Buffer Status Report, BSR, according to the buffer status information.

18. The UE according to claim 14, further configured to trigger the PHR when any one or more first criteria are met.

19. The UE according to claim 14, further configured to trigger the PHR when the data volume exceeds a threshold.

20. A network node configured to handle a Small Data Transmission, SDT, from a User Equipment, UE in a wireless communications network, which UE is adapted to be in a Radio Resource Control, RRC, inactive state, the network node further configured to:
when the data volume for an SDT to be transmitted to the network node is adapted to require at least one transmission outside a Random Access, RA, procedure, receive a Power Headroom Report, PHR, from the UE; and
handle a part of the data volume of the SDT that is adapted to be to be transmitted after the RA based on the PHR.

21. The network node according to claim 20, further configured to receive, the PHR when a second criterion is met.

22. The network node according to claim 20, further configured to receive, a Buffer Status Report, BSR, which BSR relates to the data volume for the SDT to be transmitted to the network node.
